(19) United States
(12) Patent Application Publication
(10) Pub. No.: US 2026/0029995 A1
(43) Pub. Date: Jan. 29, 2026

(54) METHOD FOR GENERATING A CONTROL PROGRAM FOR AN AUTOMATION SYSTEM AND DEVELOPMENT ENVIRONMENT

(71) Applicant: Beckhoff Automation GmbH, Verl (DE)

(72) Inventor: Ralf Dreesen, Rietberg (DE)

(21) Appl. No.: 19/347,838

(22) Filed: Oct. 2, 2025

Related U.S. Application Data
(63) Continuation of application No. PCT/EP2024/064629, filed on May 28, 2024.

(30) Foreign Application Priority Data
Sep. 27, 2023 (DE) 10 2023 126 332.3

(51) Int. Cl. G06F 8/34; G05B 19/042; G06F 8/41; G06F 11/362; G06F 16/34

(52) U.S. Cl. CPC G06F 8/34; G05B 19/0426; G06F 8/41; G06F 11/362; G06F 16/345

(57) ABSTRACT

A computer-implemented method for generating a control program for an automation system includes receiving input data for a control program of an automation system by a development environment, generating the graphical diagram of the graphical programming language based on the input data with the aid of a graphical editor unit, displaying the graphical diagram in the graphical editor unit, translating the graphical diagram into a textual intermediate representation of the graphical diagram by a translation module, displaying the textual intermediate representation of the graphical diagram in a textual editor unit, and generating the control program based on the textual intermediate representation of the graphical diagram, and/or based on the graphical diagram.

### CROSS-REFERENCE TO RELATED APPLICATIONS

This application s a continuation of International Patent Application No. PCT/EP2024/064629, filed May 28, 2024, entitled “Method for Generating a Control Program for an Automation Environment, and Development Environment,” which claims the priority of German patent application DE 10 2023 126 332.3, filed Sep. 27, 2023, entitled “Verfahren zum Generieren cines Steuerprogramms für cin Automatisierungssystem und Entwicklungsumgebung,” each of which is incorporated by reference herein, in the entirety and for all purposes.

### BACKGROUND

The application relates to a method for generating a control program for an automation system and to a development environment.

### FIELD

Graphical programming languages are known from the prior art for the graphical programming of programmable logic controllers (PLCs) in automation technology. Three graphical programming languages are defined in the IEC 61131-3 standard: ladder diagram, function block language and sequence language. The aforementioned graphical programming languages allow for user-friendly graphical programming in which graphical diagrams may be generated graphically as graphical representations for control programs to be created for programmable logic controllers by adding and/or removing predefined graphical program objects.

Graphical programming languages are known from the prior art for the graphical programming of programmable logic controllers (PLCs) in automation technology. Three graphical programming languages are defined in the IEC 61131-3 standard: ladder diagram, function block language and sequence language. The aforementioned graphical programming languages allow for user-friendly graphical programming in which graphical diagrams may be generated graphically as graphical representations for control programs to be created for programmable logic controllers by adding and/or removing predefined graphical program objects.

Various development environments are known from the prior art for such graphical programming. The development environments known from the prior art each comprise a graphical editor unit in which graphical diagrams may be generated by the user by adding and/or removing the graphical program objects predefined by the graphical programming language.

However, the development environments known from the prior art exclusively allow for graphical representation and programming for the aforementioned graphical programming languages. The user is therefore limited to graphical programming in the graphical editor unit.

Graphical programming has many advantages over textual programming, such as the relatively easy learning of the programming language. At the same time, however, graphical programming also has some disadvantages compared to textual programming.

### SUMMARY

An improved method for generating a control program for an automation system and an improved development environment are provided.

### EXAMPLES

According to an aspect of the application, a computer-implemented method for generating a control program for an automation system is provided, comprising:
receiving input data for a control program of an automation system with the aid of a development environment in a receiving step, wherein the input data describes a graphical diagram of a graphical programming language, and wherein the graphical diagram graphically represents at least a part of a control program for an automation system according to the graphical programming language;
generating the graphical diagram of the graphical programming language based on the input data with the aid of a graphical editor unit of the development environment in a first generating step;
displaying the graphical diagram in the graphical editor unit of the development environment in a first displaying step;
translating the graphical diagram of the graphical programming language into a textual intermediate representation of the graphical diagram with the aid of a translation module of the development environment in a first translating step, wherein the textual intermediate representation provides a textual description of the graphical diagram;
displaying the textual intermediate representation of the graphical diagram in a textual editor unit of the development environment in a second displaying step; and
generating the control program based on the textual intermediate representation of the graphical diagram of the graphical programming language and/or based on the graphical diagram in a second generating step.

This may achieve the technical advantage of an improved computer-implemented method for generating a control program for an automation system. The method according to the application is carried out by a correspondingly embodied development environment having a graphical editor unit, a textual editor unit, and a translation module. The graphical editor unit allows for graphical programming in accordance with a graphical programming language. The textual editor unit allows for textual programming of the control program in accordance with the graphical programming language.

The translation module allows for translating between the graphical diagrams of the graphical programming language created with the aid of graphical programming and textual intermediate representations of the graphical diagrams.

The method provides for generating a graphical diagram valid according to a selected graphical programming language based on input data by the graphical editor unit and displaying it in the graphical editor unit to a user of the development environment. The graphical diagram represents at least part of the control program to be generated for the automation system in accordance with the rules of the selected graphical programming language.

For this purpose, the graphical diagram comprises graphical program objects that correspond to program objects of the control program.

The translation module translates the graphical diagram into a corresponding textual intermediate representation. In this context, the textual intermediate representation represents a textual description of the graphical diagram, including the graphical program objects contained therein. According to the application, the textual intermediate representation is in a form that is readable for the user of the development environment.

The textual intermediate representation generated by the translation module is then displayed to the user in the textual editor unit. The user may thus check the accuracy of the graphical diagram by viewing the textual intermediate representation in the textual editor unit and immediately identify any errors in the graphical diagram. This allows for improved programming of control programs for automation systems based on graphical programming languages.

In particular, when errors in the graphical diagram are identified, the user may correct or modify the graphical diagram accordingly by viewing the textual intermediate representation, thereby reducing, for example, the computing capacity and runtime required to execute the control program. In addition to simplified programming, this also allows for improved control programs.

Furthermore, a user who is not familiar with textual programming languages is able to interpret the program code more easily on the basis of the graphical representation and to detect and correct errors in the program code or on the machine more quickly. Downtimes of the automation system to be controlled may thus be substantially reduced. In return, an experienced user, such as a software developer who is familiar with all the textual and graphical programming languages used, has more opportunities of generating in a more efficient and purposeful manner if the user may generate in a textual programming language.

Finally, the method according to the application provides for generating the correspondingly programmed control program based on the graphical diagram and/or based on the textual intermediate representation of the graphical diagram. The control program may thus be generated directly based on the textual intermediate representation of the graphical diagram. This means that no additional textual intermediate representation is required for the graphical diagram, which is required exclusively for storing or compiling the control program based on the graphical diagram.

Instead, the textual intermediate representation that was previously displayed to the user in the textual editor unit for review and that is written in a form readable by the user is used directly as an intermediate representation for storing the control program created based on the graphical diagram of the graphical programming language and for compiling the control program.

This further simplifies the programming of the control program based on the graphical programming language, which only uses a textual intermediate representation of the graphical diagrams, both for storing the control program and for compiling the control program, and additionally for displaying and checking the corresponding graphical diagram by the user.

The use of the textual intermediate representation also ensures good compatibility of the program code created with version controllers. In particular, the program code created may be stored in textual form in the textual intermediate representation. The program code stored in such a way may be easily managed in version controllers.

In addition, storing the program code in textual form reduces the amount of storage space required.

The method according to the application also allows seamless switching between textual and graphical programming and representation: The developer may develop the program code in textual or graphical programming, depending on preference or the specific case.

Even if the sequence control of the automation system is programmed in a textual manner, it and its current progress may be displayed graphically to the user, for example on a user interface (HMI). This makes it easier to understand the program code and the processes within the automation system.

Furthermore, the textual intermediate representation allows for copying, deleting and moving complete executable program objects in their entirety.

For example, a user may change the behavior of a machine control by modifying an executable program object, wherein the changes are made in graphical form. The user may then transfer the modified executable program object as a coherent text, for example by e-mail, fax, letter, dictation, telegram, or stone tablet, to a co-worker. The co-worker is then able to replace the active executable program object with the transferred program object, thereby changing the behavior of the machine consistently in a single step.

Furthermore, the textual intermediate representation provides a clear overview for the user, e.g., by displaying a class in its entirety in a text editor, including the behavior of all methods of the class.

In addition, the method allows for the simple generation of program code that contains executable program objects with textualized behavior.

For example, a machine manufacturer markets a machine in a variety of variants, which result from combinations of different parameters specified by a customer. The variants differ both in the physical design of the machine and in the control program.

Based on the parameters, the variant-specific parts of the control program are generated as text by a code generator. This may also include graphical behavior, e.g., variant-specific sequence control in AS sequence language or a variant-specific control algorithm in FBS function block language. Unlike manual adaptation, code generation is automated and may be integrated into an ordering process.

Furthermore, the method allows for simple and quick changes to a graphical program code by changing the textualized program code, for example, using a textual search/replace function.

According to the application, the input data of the graphical diagram describe properties of the graphical program objects of the graphical diagram and are suitable for being read in by the graphical editor unit and allow for the graphical editor unit to generate a corresponding graphical diagram.

### BRIEF DESCRIPTION OF THE DRAWINGS

The application is described in more detail with reference to the accompanying figures, in which:

FIG. 1 is a schematic representation of a system for generating a control program for an automation system according to an embodiment;

FIG. 2 is a further schematic representation of a system for generating a control program for an automation system according to a further embodiment;

FIG. 3 shows a flowchart of a method for generating a control program for an automation system according to an embodiment;

FIG. 4 shows a further flowchart of the method for generating a control program for an automation system according to a further embodiment;

FIG. 5 shows a further flowchart of the method for generating a control program for an automation system according to a further embodiment; and

FIG. 6 shows a further flowchart of the method for generating a control program for an automation system according to a further embodiment.

### DETAILED DESCRIPTION

A graphical diagram of a graphical programming language is, within the meaning of the application, a graphical representation in accordance with the rules of the respective graphical programming language of a control program that may be created by the graphical programming language. The graphical diagram comprises at least one graphical program object. The graphical program object is a graphical representation of a program object of the respective control program.

The graphical diagram may be displayed graphically in a corresponding display unit of a graphical editor unit in accordance with the rules of the graphical programming language. The display unit is embodied as a software module of the graphical editor unit.

According to an embodiment, the receiving step comprises:
receiving graphical input commands from a user of a development environment by the graphical editor unit of the development environment in a first programming step, wherein the input data comprise the graphical input commands,
wherein the graphical input commands comprise programming commands for adding and/or removing graphical program objects of the graphical diagram, and wherein the graphical program objects are partial elements of the graphical diagram and represent executable program objects of the control program.

This achieves the technical advantage that the method according to the application allows for taking into account graphical programming of the control program. In this case, the input data is provided by graphical programming commands entered by the user of the development environment. The present embodiment thus describes the case in which the user creates or modifies the graphical diagram by entering corresponding input commands in the graphical editor unit, for example by adding or removing corresponding graphical program objects.

The input data is thus created, exclusively, as the case may be, by the user's input commands during the graphical programming process, in which the user modifies an existing graphical diagram or creates a new graphical diagram from scratch in accordance with the rules of the graphical programming language of the graphical editor unit. This graphical diagram, which has been modified or newly created by the graphical programming process, is then translated into a corresponding textual intermediate representation in accordance with the above descriptions and displayed to the user in the textual editor unit.

Subsequently, the control program to be generated is created based on the graphical diagram created in the graphical programming process and/or based on the corresponding textual intermediate representation. In the embodiment shown, the user may thus modify or regenerate a corresponding graphical diagram by executing the graphical input commands in the graphical editor unit in accordance with the rules of the selected graphical programming language.

The graphical diagram modified or newly created in the graphical programming process is then translated into a corresponding textual intermediate representation readable by the user and displayed to the user of the textual editor unit for review.

According to an embodiment, the receiving step comprises:
reading in a program file in a reading step, wherein the program file contains the input data of the graphical diagram in textual form, wherein the graphical program objects of the graphical diagram are described textually by the input data; and wherein the first generating step comprises:
translating the textual input data into the graphical diagram with the aid of the translation module in a second translating step.

This may achieve the technical advantage that, in the embodiment described, the graphical diagram is generated based on a pre-stored program file containing the input data. The embodiment described thus describes the case in which a graphical diagram already generated in an earlier graphical programming process which is stored in textual form in the pre-stored program file, is read in by the development environment and displayed to the user in the form of the graphical diagram in the graphical editor unit and in the form of the textual intermediate representation generated by the translation process and written in a form readable by the user in the corresponding textual editor unit.

Based on this, the user may carry out a further graphical programming operation in accordance with the embodiment described above and modify the graphical intermediate representation accordingly by adding or removing graphical program objects in accordance with the graphical input commands described.

According to an embodiment, the method further comprises:
receiving textual input commands from the user via the textual editor unit of the development environment in a textual programming step, wherein the textual input commands add or remove textual program objects as textual representations of corresponding graphical program objects of the graphical diagram to or from the textual intermediate representation of the graphical diagram;
generating a modified textual intermediate representation based on the textual input commands and the textual intermediate representation of the graphical diagram in a third generating step;
translating the modified textual intermediate representation into a correspondingly modified graphical diagram of the graphical programming language and/or translating textual modifications of the textual intermediate representation caused by the textual input commands into graphical modifications of the graphical diagram with the aid of the translation module in a third translating step, wherein the textual modification comprises at least one newly added or deleted textual program object, and wherein the graphical modifications comprise at least one newly added or deleted graphical program object;
displaying the modified graphical diagram instead of the graphical diagram and/or displaying the graphical modifications in the graphical diagram in the graphical editor unit in a third displaying step; and
generating the control program based on the modified textual intermediate representation of the modified graphical diagram and/or based on the modified graphical diagram in the second generating step.

This achieves the technical advantage that the described method allows the user of the development environment to modify the existing graphical diagram based on the textual intermediate representation by executing a textual programming operation taking into account the textual editor unit. The user may thus make changes to the textual intermediate representation of the graphical diagram displayed in the textual editor unit by executing a textual programming operation and thereby create a modified textual intermediate representation.

This may result in substantial practical and timely benefits in the programming process, as program parts may be automatically renamed, replaced, or modified in the textual representation of the program code, for example. Such processes are much more time-consuming in the graphical representation, as there is no automatic search/replace function.

To this end, the user may enter corresponding input commands into the textual editor unit in order to modify the displayed textual intermediate representation. The textual input commands include adding or removing textual program objects from the textual intermediate representation. According to the application, the textual program objects are textual representations of the graphical program objects of the graphical diagram. The graphical program objects are predefined by the rules of the selected graphical programming language.

When the textual intermediate representation is changed in the textual programming process, the textual editor unit receives the corresponding textual input commands entered by the user and makes a corresponding change to the textual intermediate representation displayed in the textual editor unit. This generates a modified textual intermediate representation.

The translation module subsequently translates the modified textual intermediate representation and generates a correspondingly modified graphical diagram. The graphical diagram is then displayed to the user in the graphical editor unit.

The user may thus modify the graphical diagram previously generated based on the input data, i.e., based on the graphical input commands executed in the graphical programming process or based on the program file, by executing a textual programming process in the textual editor unit, and based on this, generate a modified textual intermediate representation and a correspondingly modified graphical diagram.

The modified graphical diagram and the modified textual intermediate representation represent graphical and textual equivalents of the same control program to be generated. The same applies to the graphical diagram described above and the corresponding textual intermediate representation.

The mentioned embodiment of the method according to the application thus provides the user with the option of generating the control program in the selected graphical programming language both in a graphical programming process and in a textual programming process. The user may switch between graphical programming and textual programming as desired, since changes made in the graphical editor unit are immediately reflected in the corresponding textual intermediate representation and, conversely, changes made by the user in the textual intermediate representation are immediately reflected in the corresponding graphical diagram.

The graphical diagram and the textual intermediate representation thus represent a clear correspondence to each other at all times, regardless of in which editor unit changes were made by the user.

This further substantially simplifies the programming process. Some processes involved in generating the control program are easier to carry out in the graphical editor unit, while other processes are easier to accomplish textually. For example, multiplying program objects in the textual intermediate representation is much easier to do using copy & paste than in the graphical diagram in which each graphical program object must be multiplied individually and linked to the existing graphical program objects.

This moreover simplifies the resulting control program, as the textual programming in the textual editor unit may be used to generate a simplified graphical diagram, which may lead to a simplified control program with reduced runtime and reduced computing capacity.

According to an embodiment, the method further comprises displaying the modified textual intermediate representation of the modified graphical diagram in the textual editor unit in a fourth displaying step.

This may achieve the technical advantage that displaying the textual intermediate representation modified in the textual programming process in the textual editor unit allows the user to identify errors or weaknesses in the modified graphical diagram generated by the textual programming and corresponding to the modified textual intermediate representation based on the displayed modified textual intermediate representation.

According to an embodiment, the first translating step further comprises:
determining the graphical program objects and a graphical behavior of the graphical diagram in a behavior determining step, wherein the graphical behavior describes a graphical representation of a program sequence of the control program; and
translating the graphical program objects and the graphical behavior of the graphical diagram into textual program objects and a textual behavior of the textual intermediate representation in a behavior translating step, wherein the textual behavior represents a textual intermediate representation of the sequence of the control program.

This may achieve the technical advantage of allowing for precise translation between the graphical diagrams and the corresponding textual intermediate representations. For this purpose, the graphical program objects of the graphical diagram are first identified and then individually translated into corresponding textual program objects during the translation process.

As already described above, the graphical program objects are predefined by the rules of the appropriately selected graphical programming language and correspond to program objects of the control program to be generated. The corresponding textual program objects are textual representations of the respective graphical program objects of the graphical diagram and thus represent the corresponding executable program objects of the control program in textual form.

The textual program objects are thus not independent program objects, but are primarily textual equivalents of the graphical program objects of the graphical diagram, which, as already mentioned, are predefined by the rules of the graphical programming language.

Furthermore, a graphical behavior is determined in the graphical diagram. The graphical behavior describes a program sequence of the graphical diagram and defines links between the individual graphical program objects within the graphical diagram. The graphical behavior thus defines the program-related temporal execution of the individual graphical program objects and the interaction of the individual graphical program objects within the graphical diagram.

Based on the graphical behavior, a corresponding textual behavior is generated. The textual behavior describes a program sequence within the textual intermediate representation in a corresponding manner and is a textual equivalent of the graphical behavior. In the textual behavior, the program-related timing of the individual textual program objects and the links between the textual program objects in the textual intermediate representation are defined in accordance with the graphical behavior.

In the course of determining the graphical behavior, graphical object positions may also be determined for the graphical program objects. The graphical object positions describe the positions of the individual graphical objects within the graphical diagram or the graphical behavior, respectively. The graphical object positions of the individual graphical program objects are thus assigned to the individual graphical program objects within the sequence of the graphical diagram, with the aid of which the arrangement of the individual graphical program objects relative to each other is defined.

The graphical object positions of the graphical program objects may thus be used to define an execution sequence for the graphical program objects within the graphical diagram or graphical behavior. The individual graphical program objects may thus be assigned to each other via the graphical object positions, and a program sequence may be defined in which the graphical program objects are executed according to the graphical object positions assigned to them.

During the translation process, the graphical object positions of the graphical program objects may be converted into corresponding textual object positions of the respective textual program objects.

The textual object positions of the respective textual program objects define a sequence of the arrangement of the textual program objects within the textual behavior and a corresponding program sequence of the control program.

Within the framework of the application, a behavior is a description of how a function of the program works or operates, respectively. The behavior includes, for example, a procedure for calculating a function result based on the parameters of the function.

According to an embodiment, the first translating step comprises:
carrying out a line-by-line translation in a line translating step,
wherein in the line-by-line translation, at least one textual program object in the form of at least one textual line of the textual intermediate representation is assigned to each graphical program object, and wherein the textual lines provide unique descriptions of the respective graphical program objects.

This achieves the technical advantage that, due to the line-by-line translation, the textual program objects corresponding to the graphical program objects of the graphical diagram are each represented by at least one textual line. The line-by-line representation of the textual program objects in the textual intermediate representation ensures that the textual intermediate representation is easy for the user to read. The textual program objects are thus preferably represented in exactly one textual line within the textual intermediate representation.

This facilitates the readability of the textual intermediate representation by clearly separating the individual textual program objects from one another and making them easy to understand thanks to the line-by-line division. In addition to readability, this also facilitates programming, particularly within textual programming. Line-by-line translation also allows the textual intermediate representation of the program code to be managed in a version controller.

According to an embodiment, the first translating step comprises:
arranging the textual behavior at a behavior position within the textual intermediate representation in an arranging step,
wherein the behavior position defines a position in a program code predefined by an IEC 61131-3 standard at which a behavior of a control program is to be positioned.

This achieves the technical advantage that, by arranging the textual behavior within the textual intermediate representation at the designated behavior position, the textual intermediate representation complies with the requirements of IEC 61131-3. Furthermore, the coherent code of the textual intermediate representation is easier for the user to read, since the behavior is arranged at the designated position.

Within the framework of the application, a behavior position defines a place within the program code where the behavior must be located. The behavior position may be specified by guidelines of the respective programming language. In the field of automation and the programming languages used there, the behavior position may be specified in the IEC 61131-3 standard.

According to an embodiment, the first generating step comprises:
determining the identities of the graphical program objects of the graphical diagram in an identity determining step, wherein the identities of the graphical program objects allow for the respective graphical program objects to be uniquely identified; and wherein the line translating step comprises:
integrating the identities of the graphical program objects into the respective textual lines of the textual intermediate representation assigned to the graphical program objects in an integrating step.

This achieves the technical advantage that, by determining the identities of the graphical program objects and integrating the respective identities into the corresponding textual program objects, a clear correspondence between the graphical program objects of the graphical diagram and the textual program objects of the textual intermediate representation is ensured. Furthermore, integrating the identities of the graphical program objects into the corresponding textual program objects ensures that links between the graphical program objects in the graphical diagram are correctly taken into account in the textual program objects of the textual intermediate representation.

By clearly specifying the identities within the textual program objects, which not only identifies the respective textual program objects but also displays the links to other textual program objects, the user may easily determine the correctness of the textual intermediate representation in relation to the graphical diagram by looking at the textual intermediate representation displayed in the textual editor unit.

This in turn facilitates the verification of the correctness of the textual intermediate representation, which in turn facilitates the programming process, which in turn may lead to improved control programs.

According to an embodiment, the method further comprises:
summarizing the textual intermediate representation of the graphical diagram with at least one further intermediate representation of at least one further graphical diagram to form a total textual intermediate representation in a summarizing step,
wherein in the total intermediate representation a plurality of different textual intermediate representations of a plurality of different graphical diagrams are summarized to form a coherent code in textual form.

This achieves the technical advantage that a coherent code for the entire control program may be provided in the form of the overall textual intermediate representation. Individual executable objects of the control program may be represented or programmed using different graphical diagrams, also using, as the case may be, different graphical programming languages. The respective textual intermediate representations may be combined in the textual overall intermediate representation. This means that only one coherent code in the form of the textual overall intermediate representation is required to represent the entire control program.

The text of the overall textual intermediate representation is also readable by the user as a coherent text. The entire control program is thus stored in a common file and is available to the user in a readable form. The behavior of the respective graphical diagrams is arranged in the textual overall intermediate representation according to the behavior positions specified by the IEC 61131-3 standard. The textual overall intermediate representation thus provides a textual form of an executable control program that meets the requirements of the IEC 61131-3 standard.

According to an embodiment, the second generating step comprises carrying out a debugging process based on the textual intermediate representation of the graphical diagram in a debugging step.

This achieves the technical advantage of allowing for debugging the generated control program based directly on the textual intermediate representation of the graphical diagram. The textual intermediate representation is thus not only a textual representation of the graphical diagram that may be displayed to the user in the textual editor unit for correction purposes. The textual intermediate representation is also used directly as a basis in further compilation processes of the control program.

The graphical diagram, on the other hand, is merely a graphical representation of the textual intermediate representation, which may be displayed to the user in the graphical editor unit and which the user may modify with the aid of the graphical programming process known in the prior art for graphical programming languages. The textual intermediate representation, on the other hand, represents the representation that is decisive for generating the control program in the compilation process.

According to an embodiment, the second generating step comprises generating a binary representation of the control program in a binary code generating step.

This achieves the technical advantage that the binary representation of the control program may be used to provide an executable representation of the control program.

According to an embodiment, the method further comprises storing the textual representation in a representation file in a storing step.

This achieves the technical advantage that the control program may be stored by storing the textual intermediate representation in a representation file. As described above, by reading the representation file in the form of a program file into the development environment, the corresponding textual intermediate representation may be converted into a corresponding graphical diagram and displayed to the user for further processing in the graphical editor unit.

According to an embodiment, the graphical programming language is any one of the following: contact plan, function block language, sequence language.

This achieves the technical advantage that the method according to the application may be applied to the graphical programming languages commonly used in automation technology and defined in the IEC 61131-3 standard.

According to an embodiment, a syntax of the textual intermediate representation and the modified textual intermediate representation is conflict-free with a syntax of the graphical programming language.

This achieves the technical advantage that the conflict-free syntax of the textual intermediate representation with the syntax of the graphical programming language allows for providing a clear textual intermediate representation that may be reliably used for programming a control program based on the graphical programming language.

According to an aspect, a development environment is provided with a graphical editor unit, a textual editor unit, and a translation module, wherein the development environment is set up to carry out the method for generating a control program for an automation system according to one of the preceding embodiments.

This achieves the technical advantage of providing an improved development environment that is set up to carry out the method according to the application for generating a control program for an automation system having the above-mentioned technical advantages.

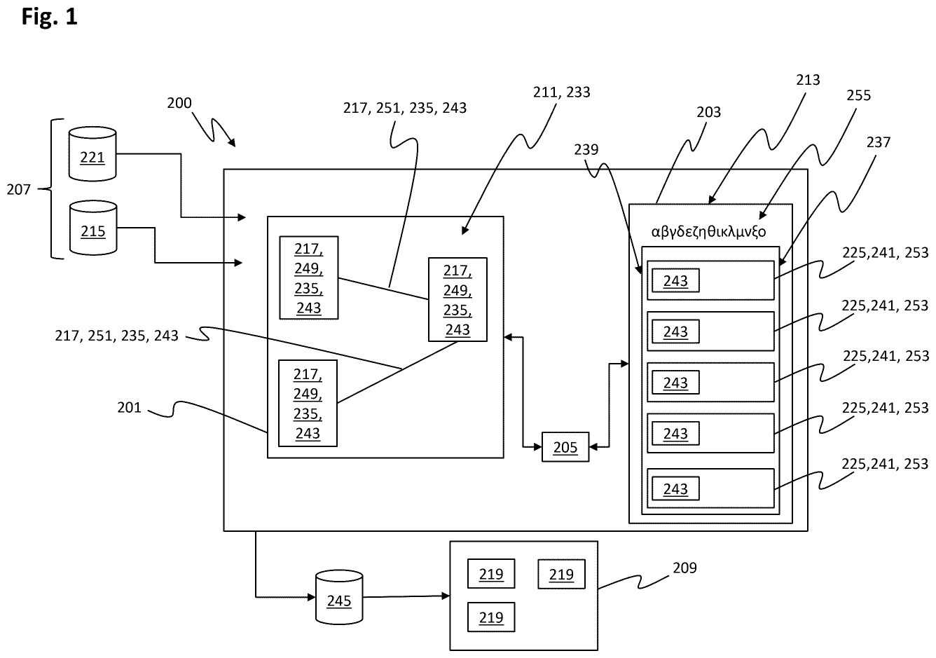

FIG. 1 shows a schematic representation of a system for generating a control program 209 for an automation system according to an embodiment.

According to the application, a development environment 200 suitable for carrying out the method according to the application for generating a control program for an automation system comprises a graphical editor unit 201, a textual editor unit 203, and a translation module 205.

The graphical editor unit 201 is embodied to achieve a graphical programming process according to a graphical programming language known from the prior art. The graphical editor unit 201 may have all input devices and display devices known from the prior art that are required for executing a graphical programming process.

The textual editor unit 203 is embodied for a textual programming process. For this purpose, the textual editor unit 203 may comprise all display devices and input devices known from the prior art that are required to execute a textual programming process.

The translation module 205 is embodied according to the application to translate a translation process between the graphical diagrams 211 of a predefined graphical programming language displayed or generated in the graphical editor unit 201 into corresponding textual intermediate representations 213. In addition, the translation module 205 is set up to carry out a reverse translation in which textual intermediate representations 213 displayed or generated in the textual editor unit 203 are translated into corresponding graphical diagrams 211 of a previously selected graphical programming language.

According to an embodiment, the graphical programming languages taken into account by the method according to the application or the development environment 200 according to the application include the languages contact plan, function block language, and sequence language, which are each predefined in the IEC 61131-3 standard for automation technology.

The translation module 205 is accordingly capable of converting the aforementioned programming languages into textual intermediate representations 213.

According to the application, the textual intermediate representations 213 are written in a form that is readable by the user. The textual intermediate representations 213 are written in a known and readable form that is based on natural languages such as English, German, Spanish, Mandarin, or a similar common world language.

The letters, terms, or characters/special characters used are taken from the aforementioned natural languages. In addition, the textual intermediate representations 213 are displayed in line form and may be read within a display field of the textual editor unit 203 from top left to bottom right, or follow another recognized convention for readability.

In addition to the components shown, the development environment 200 may comprise additional components that are required for a compilation process or a programming process of a control program. These may comprise input or output interfaces, a compiler, a debugging module, and other components known from the prior art for programming.

To carry out the method for generating a control program for an automation system, the development environment 200 first receives input data 207 for a control program 209. The input data 207 comprises descriptions of the graphical diagram 211 of a previously selected graphical programming language.

Based on the input data 207, the graphical editor unit 201 then generates a graphical diagram 211 corresponding to the input data 207 and displays it in the graphical editor unit 201. The graphical editor unit 201 comprises a corresponding display unit for this purpose.

If the input data 207 is in textual form, the input data 207 is first translated into a graphical diagram 211 by the translation module 205 before being displayed in the graphical editor unit 201.

In the example shown in FIG. 1, the graphical diagram 211 comprises five graphical program objects 217. The five graphical program objects 217 comprise three node objects 249, which are each connected to one another via two edge objects 251.

The graphical program objects 217 represent graphical representations of program objects 219 of the control program 209.

The graphical diagram 211 shown herein is only an example of possible graphical diagrams 211 of the programming languages contact plan, function block language, and sequence language.

In a subsequent translating step, the graphical diagram 211 displayed in the graphical editor unit 201 is translated by the translation module 205 into a corresponding textual intermediate representation 213. The textual intermediate representation 213 is then displayed in the textual editor unit 203. For this purpose, the textual editor unit 203 comprises a corresponding display device.

In the textual intermediate representation 213, five textual program objects 225 of the textual intermediate representation 213 are defined for the five graphical program objects 217 of the graphical diagram 211. The textual program objects 225 represent textual representations or textual descriptions of the graphical program objects 217 of the graphical diagram.

The textual intermediate representation 213 may be viewed by the user of the development environment 200 in the textual editor unit 203. This allows errors in the graphical diagram 211 to be detected and corrected if necessary.

The control program 209 may then be generated based on the graphical diagram 211 and/or based on the textual intermediate representation 213.

According to an embodiment, the input data 207 comprise a program file 221. A graphical diagram 211 is stored in textual form in the program file 221.

By reading in the information from the program file 221 via the development environment 200, the graphical editor unit 201 may generate a graphical diagram 211 corresponding to the input data of the program file 221 and display it to the user in the editor unit 201. For this purpose, the translation module 205 may first translate the information stored in textual form in the program file 221 into a corresponding graphical diagram 211.

The above embodiment describes the case in which an existing graphical diagram 211 stored in the program file 221 is loaded by the development environment 200 and displayed to the user in the graphical editor unit 201 for further processing.

According to a further embodiment, the input data 207 comprise graphical input commands 215. The graphical input commands 215 are programming commands that are transmitted by a user of the development environment 200 to the graphical editor unit 201 in a graphical programming process. The graphical input commands 215 may, for example, comprise adding or removing graphical program objects 217 from the graphical diagram 211. The above-mentioned embodiment describes the case in which, during a graphical programming process by a user of the development environment 200 within the graphical editor unit 201, a graphical diagram 211 is modified or a graphical diagram 211 is completely regenerated.

The present application also comprises a combination of the two embodiments, in which, for example, an existing graphical diagram 211 stored in textual form in the program file 221 is first uploaded to the graphical editor unit 201 by reading in the information from the program file 221 and is displayed there to the user for further processing.

By executing a graphical programming process in which the user transmits graphical input commands 215 in the form of adding or removing graphical program objects 217 to or from the graphical diagram 211 to the graphical editor unit 201, the graphical diagram 211 previously loaded into the graphical editor unit 201 based on the information in the program file 221 is modified or further developed.

According to an embodiment, the graphical program objects 217 and a graphical behavior 233 of the graphical diagram 211 are first determined in order to translate the graphical diagram 211 into the textual intermediate representation 213. The graphical behavior is given by the totality of all graphical program objects 217. The graphical behavior 233 describes the program flow of the graphical diagram 211. The graphical diagram 211 is a graphical formal description of the behavior of the program code.

The graphical behavior 233 describes the program flow of the graphical diagram 211. The graphical diagram 211 is a graphical formal description of the behavior of the program code.

In the translation of the graphical diagram 211 into the textual intermediate representation 213, at least one graphical program object 217 is translated into at least one corresponding textual program object 225. The at least one textual program object 225 represents a textual representation of the at least one graphical program object 217 and describes the same program object 219 of the control program 209 as the corresponding graphical program object 217 of the graphical diagram 211.

The graphical behavior may be determined by taking into account volatile representations of the graphical diagram 211. As is known from the prior art, graphical diagrams 211 written in graphical programming languages are represented in volatile representations. The volatile representations are not stored permanently in the memory but exist exclusively during the creation or display of the graphical diagrams in the graphical editor unit 201 in the working memory of the computer executing the development environment 200.

During processing of the graphical diagram 211 in the development environment 200, the volatile representations are stored in the RAM of the computer executing the development environment 200 as bit sequences and represent the individual components, including the graphical program objects 217 of the graphical behavior of the graphical diagram 211.

By reading in the volatile representations, the graphical program objects 217 and the graphical behavior may be identified by the development environment 200. By reading in, the position information and size information of the graphical diagram 211 and the graphical program objects 217 contained therein may also be determined. The position and size information describe the positions and sizes at and with the aid of which the individual components, i.e., the graphical program objects 217, are displayed in the graphical editor unit 201.

Taking into account the volatile representations of the graphical diagram 211, the corresponding textual intermediate representation 213, including the textual program objects 225 and the textual behavior 237, may be translated from the graphical diagram 211.

According to an embodiment, the translation of the graphical diagram 211 into the textual intermediate representation 213 is carried out line by line. In this case, a corresponding textual program object 225 is assigned to the at least one graphical program object 217. The textual program object 225 is represented by at least one textual line 241 of the textual intermediate representation 213. Preferably, the textual program objects 225 are represented by exactly one textual line 241 within the textual intermediate representation 213.

The textual program objects 225 represented in the form of textual lines 241 may be arranged in the textual intermediate representation 213 according to the respective identities 243 of the graphical program objects 217 integrated into the textual program objects 225.

According to an embodiment, identities 243 of the graphical program objects 217 are determined for translating the graphical diagram 211 into the textual intermediate representation 213. The identities 243 allow for unique identification of the individual graphical program objects 217. During the line-by-line translation of the graphical diagram 211 into the textual intermediate representation 213, the identities 243 of the graphical program objects 217 are integrated into the corresponding textual program objects 225.

The identities 243 may, for example, be embodied as sequences of digits or letters, which allow for unique identification of the graphical program objects 217 or the textual program objects 225.

Furthermore, during translation, graphical object positions 235 of the graphical program objects 217 may be determined within the graphical diagram 211. The graphical object positions 235 assign positions within the graphical behavior to the respective graphical program objects 217 and assign the graphical program objects 217 to one another. Using the graphical object positions 235, an execution sequence of the graphical program objects 217 within a program sequence of the graphical diagram 211 may be defined.

In the translation process, the graphical object positions 235 assigned to the graphical program objects 217 may be converted into corresponding textual object positions 253 and assigned to the respective textual program objects 225. The textual program objects 225 may be assigned to one another via the textual object positions 253, and a corresponding execution sequence of the textual program objects 225 may be defined. This may be used to define a corresponding program sequence of the textual behavior.

The textual program objects 225 thus provide a unique textual description of the respective graphical program objects 217. The textual description may include information regarding the type of the respective graphical program object 217, information regarding links of the respective graphical program object 217 to other graphical program objects 217, the identities 243, and other relevant information.

For example, position information of the graphical program objects 217 may be integrated into the textual program objects 225. The position information describes position information relating to the positioning of the respective graphical program objects 217 of the graphical diagram 211 within the display device of the graphical editor unit 201. The position information may, for example, comprise x and y coordinates.

In addition to the position information, size information may also be included, which also defines a size of the respective graphical program object 217 within the display device of the graphical editor unit 201 via the x and y coordinates.

In addition to the type of the respective graphical program object 217, the corresponding textual program objects 225 may also include functionalities or functional restrictions of the respective graphical program objects 217. The types or functionalities of the graphical program objects 217 are defined by the above-mentioned standard IEC 61131-3.

The position or size information that relates exclusively to the graphical representation of the graphical program objects 217 in the graphical editor unit 201 may, for example, be defined individually by the manufacturer.

In addition to the textual program objects 225 of the textual behavior 237, the textual intermediate representation 213 comprises textual additional information 255. The textual additional information 255 may comprise, for example, data types, variable types, interfaces, or other information.

The textual additional information may be written in a basic language predefined by the IEC 61131-3 standard. The basic language describes the form in which the additional information must be written as specified by the standard.

In the embodiment shown, the textual behavior 237 is embedded in the text of the textual additional information 255 at the predefined behavior position 239. The behavior position 239 defines the position in the textual intermediate representation 213 at which the textual behavior 237 is to be arranged.

The basic language of the textual additional information 255 may be based on known natural languages and written in a form that is readable by the user.

According to an embodiment, the correspondingly generated textual intermediate representation 213 may be stored in a display file 245.

According to the application, after the textual intermediate representation 213 has been generated and the textual intermediate representation 213 has been displayed in the textual editor unit 203, the control program 209 represented by the graphical diagram 211 and/or the textual intermediate representation 213 generates the control program 209 represented by the graphical diagram 211 and/or the textual intermediate representation 213. or the textual intermediate representation 213.

Furthermore, according to an embodiment, a debugging process may first be carried out based on the textual intermediate representation 213. For this purpose, the development environment 200 may comprise a component set up to carry out a debugging process, for example in the form of a debugger.

According to an embodiment, when the control program 209 is generated, the control program 209 is generated in a binary representation. The binary representation may in turn be stored in the representation file 245.

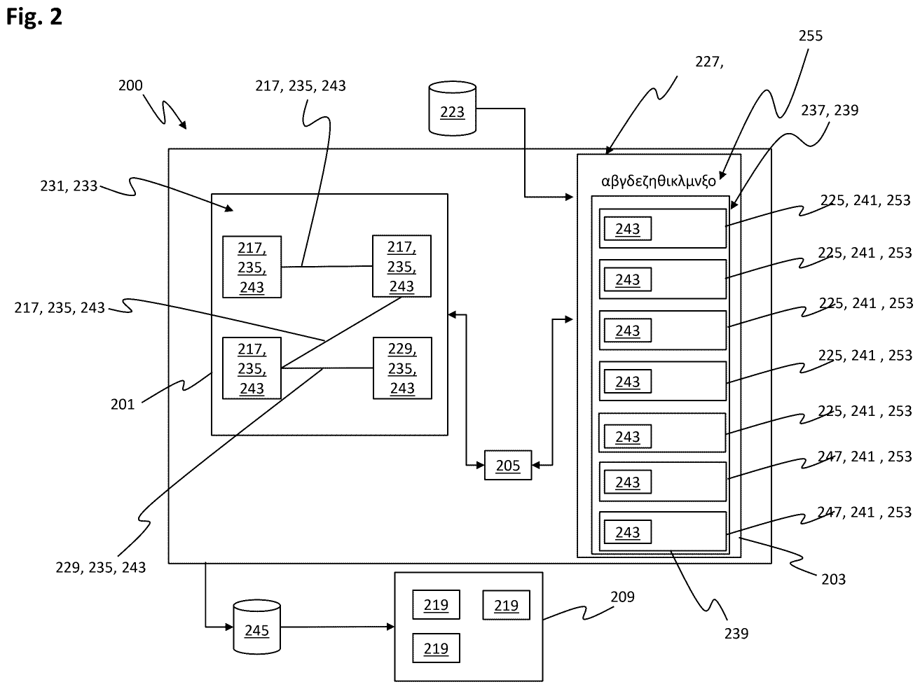

FIG. 2 shows a further schematic representation of a system for generating a control program 209 for an automation system according to a further embodiment.

The embodiment in FIG. 2 is based on the embodiment in FIG. 1 and comprises all the features described therein. If these remain unchanged in the embodiment in FIG. 2, a detailed description is omitted.

In the embodiment shown, the development environment 200 is capable of providing the user with the option of a textual programming process. The textual programming process is performed on the textual intermediate representation 213. The textual programming process thus allows the user to modify the textual intermediate representation 213 of FIG. 1, for example by adding or removing textual program objects 225 to or from the textual intermediate representation 213, modify the textual intermediate representation 213 and generate a modified textual intermediate representation 227.

For this purpose, corresponding textual input commands 223 are received by the textual editor unit 203. The textual input commands 223 describe the programming commands entered by the user during the textual programming process, with the aid of which textual program objects 225 are added or removed or modified.

Changing textual program objects 225 may include removing the textual program object to be changed and adding the corresponding changed textual program object. The textual input commands 223 may depend individually on the language used to represent the textual intermediate representations 213, 227 or the textual program objects 225, respectively, and on the respective individual textual descriptions of the graphical program objects 217 in the textual program objects 225.

The syntax of the textual intermediate representation 213, 227 may correspond at least in part to the syntax of the graphical programming language predefined in the above-mentioned standard IEC 61131-3.

In the embodiment shown, the modifications to the textual intermediate representation 213 of FIG. 1 based on the textual input commands 223 of the user comprise the addition of two further textual program objects 247. The two additional textual program objects 247 are textually represented in accordance with the original textual program objects 225 by textual lines 241 in accordance with the properties described above.

By carrying out a translation process with the aid of the translation module 205, a correspondingly modified graphical diagram 231 is generated from the modified textual intermediate representation 227. In the modified graphical diagram 231, two further graphical program objects 229 are integrated in accordance with the modified textual intermediate representation 227. In the embodiment shown, the two further graphical program objects 229 are connected to the graphical program objects 217 to form a coherent graphical diagram.

In the embodiment shown, the user is thus able to modify a previously generated graphical diagram 211 by carrying out a corresponding textual programming operation. The user is thus able to generate the control program 209 based on the previously selected graphical programming language both by carrying out a graphical programming operation as described in FIG. 1 and by carrying out a text-based programming operation as described in FIG. 2.

The user may thus select the most convenient programming method at will and may also switch between the various textual or graphical programming operations during programming. The changes made during a programming operation are immediately displayed in the other representation with the aid of translation. The changes made in the graphical diagram 211 are immediately displayed in the textual intermediate representation 213, 227 with the aid of translation. Similarly, the changes made in the textual intermediate representation 213, 227 are displayed immediately after translation in the graphical diagrams 211, 231.

Graphical program objects 217 that are newly added or deleted in the graphical diagram 211 are displayed accordingly as newly added or deleted textual program objects 225 in the textual intermediate representation 213 or integrated into or deleted from it.

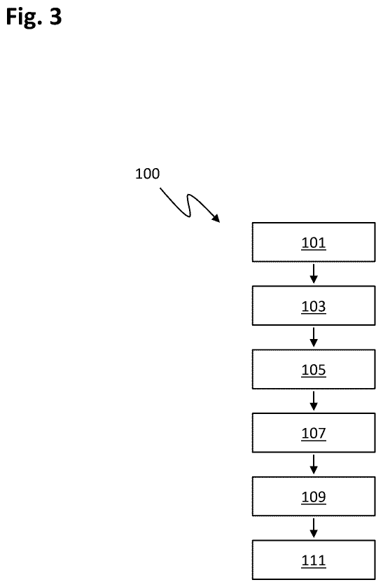

FIG. 3 shows a flowchart of a method 100 for generating a control program 209 for an automation system according to an embodiment.

In order to generate a control program for an automation system, input data 207 for a control program 209 of the automation system is first received by a development environment 200 in a receiving step 101. The input data 207 describe a graphical diagram 211 of a graphical programming language. The graphical diagram in turn graphically represents at least part of the control program 209 to be programmed in accordance with the graphical programming language.

According to an embodiment, the graphical programming language may be one of the programming languages defined in the IEC 61131-3 standard, namely ladder logic, function block language or sequence language.

In a first generating step 103, a corresponding graphical diagram 211 is then generated based on the input data 207 by a graphical editor unit 201 of the development environment 200.

In a first displaying step 105, the graphical diagram 211 is displayed in the graphical editor unit 201.

In a first translating step 107, the graphical diagram 211 of the graphical programming language is then translated by a translation module 205 of the development environment 200 into a textual intermediate representation 213 of the graphical diagram 211. The textual intermediate representation 213 represents a textual description of the graphical diagram 211.

The textual description of the textual intermediate representation 213 is embodied in such a way that the textual intermediate representation 213 is readable for a user of the development environment 200. The textual intermediate representation 213 thus comprises the complete information of the graphical diagram 211 in textual form that may easily be read by the user.

Subsequently, in a second displaying step 109, the textual intermediate representation 213 generated by translating the graphical diagram 211 is displayed in a textual editor unit 203 of the development environment 200. The user may thus check the functionality or accuracy of the corresponding graphical diagram 211 by inspecting the textual intermediate representation 213 displayed to them.

Finally, in a second generating step 111, the control program 209 is generated based on the textual intermediate representation 213 and/or based on the graphical diagram 211.

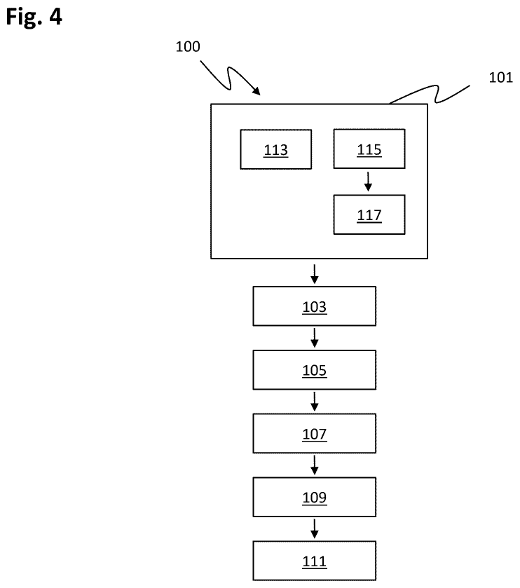

FIG. 4 shows a further flowchart of the method 100 for generating a control program 209 for an automation system according to a further embodiment.

The embodiment in FIG. 4 is based on the embodiment in FIG. 3 and comprises all the method steps described therein. If these remain unchanged, a detailed description is omitted.

The embodiment shown describes two cases for providing the input data 207 for generating the graphical diagram 211.

In one case, a program file 221 is read in by the development environment 200 in a reading step 115. A description of the graphical diagram 211 is stored in textual form in the program file 221. The input data 207 corresponds to the textual information in the program file 221.

In a second translating step 117, the textual information in the program file 221 is translated into the graphical diagram 211 with the aid of the translation module 205.

This describes the case in which, in order to generate the graphical diagram 211 based on the input data 207, a graphical diagram 211 that has already been generated and temporarily stored in textual form in the program file 221 is generated by reading the information from the program file 221 with the aid of the development environment 200. When the program file 221 is read in, the information stored in textual form in the program file 221 is first de-textualized and converted accordingly into a graphical diagram 211 that may be displayed in the graphical editor unit 201.

This covers the case in which a graphical diagram 211 that was created at an earlier point in time is loaded into the development environment 200 in order to be further processed or modified by carrying out corresponding programming operations.

In the second case, graphical input commands 215 from a user of the development environment 200 are first received by the graphical editor unit 201 in a graphical programming step 113. The input data 207 comprise the graphical input commands 215. The graphical input commands 215 in turn comprise programming commands for adding and/or removing and/or changing graphical program objects 217. The graphical program objects 217 are partial elements of the graphical diagram 211 and represent program objects 219 of the control program 209 to be generated.

This describes the case of a graphical programming operation. The graphical input commands 215 correspond to programming actions that are entered by the user during programming in accordance with the graphical programming language.

The graphical programming process allows a graphical diagram 211 that already exists and is displayed in the graphical editor unit 201 to be modified by adding or removing graphical program objects 217. Alternatively, a completely new graphical diagram 211 may be generated by carrying out the graphical programming process.

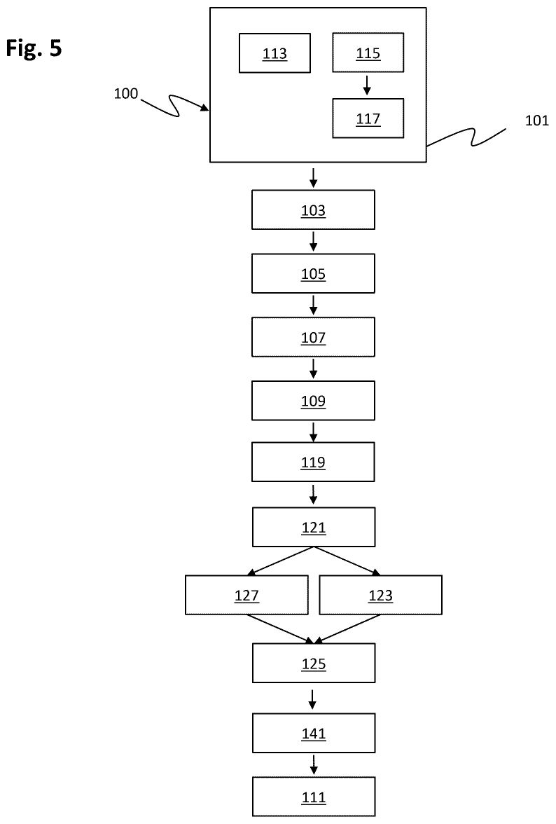

FIG. 5 shows a further flowchart of the method 100 for generating a control program 209 for an automation system according to a further embodiment.

The embodiment shown in FIG. 5 is based on the embodiment in FIG. 4 and comprises all the method steps described therein. If these remain unchanged in the embodiment shown, a detailed description is dispensed with.

In the embodiment shown, textual input commands 223 from the user are first received in a textual programming step 119 by the textual editor unit 203 of the development environment 200. The textual input commands 223 add textual program objects 225 to the textual intermediate representation 213 as textual representations of corresponding graphical program objects 217 of the graphical diagram 211 or remove them from it. The textual program objects 225 are textual representations of the graphical program objects 217 of the graphical diagram 211.

In a third generating step 121, a modified textual intermediate representation 227 is generated based on the textual input commands 223 and the textual intermediate representation 213.

In a third translating step 123, the modified textual intermediate representation 227 is then translated into a correspondingly modified graphical diagram 231. As an alternative or in addition, the textual modifications to the textual intermediate representation 213 caused by the textual input commands may be translated into graphical modifications to the graphical diagram 211.

The textual modifications comprise at least one textual program object 225 that is newly added to the textual intermediate representation 213 or deleted from the textual intermediate representation 213. The graphical modifications translated from the textual modifications accordingly comprise at least one graphical program object 217 that is newly added to the graphical diagram 211 or deleted from the graphical diagram 211.

In a fourth displaying step 127, the modified textual intermediate representation 227 of the modified graphical diagram 231 is displayed in the textual editor unit 203.

In a third displaying step 125, the modified graphical diagram 231 is displayed in the graphical editor unit 201 instead of the graphical diagram 211.

As an alternative or in addition, the graphical modifications are displayed in the graphical diagram 211. For this purpose, the graphical diagram 211 in the graphical editor unit 210 is modified in accordance with the modifications by inserting the at least one newly added graphical program object 217 of the graphical modifications into the existing graphical diagram 211.

The newly added graphical program object 217 may be marked accordingly as a new graphical program object 217, for example by color.

Accordingly, the graphical program object 217 deleted from the graphical diagram 211 in accordance with the graphical modifications may be marked accordingly, also by color, as the case may be. Alternatively, the deleted graphical program object 217 may also no longer be displayed in the graphical diagram 211.

Furthermore, in a summarizing step 141, the textual intermediate representation 213 of the graphical diagram 211 and at least one further intermediate representation of at least one further graphical diagram are combined to form a textual overall intermediate representation. In the overall intermediate representation, a plurality of different textual intermediate representations 213 of a plurality of different graphical diagrams 211 are thus combined into a coherent code in textual form.

The textual behaviors of the multiple textual intermediate representations 213 are arranged in the textual overall intermediate representation at the corresponding behavior positions.

The textual additional information 255 is arranged between the textual behaviors 237 of the various graphical diagrams in the textual overall intermediate representation. As described above, the textual additional information 255 may comprise, for example, data types, variable types, interfaces, or other information. The textual additional information arranged in the overall intermediate representation between the behaviors of the various graphical diagrams may be written in a basic language predefined by the IEC 61131-3 standard.

The basic language describes the form in which the additional information must be written as specified by the standard.

The behavior of the various graphical diagrams, on the other hand, is written in a textual sublanguage with a syntax that corresponds to the graphical structure of the programming languages defined by the IEC 61131-3 standard: ladder logic, function block language, or sequence language.

The sublanguage represents the aforementioned graphical programming languages in text form and is embodied to be readable by the user.

In the overall textual intermediate representation, the base language represents the framework of the coherent code, while the sublanguages are textual representations of the graphical diagrams, and in particular of the behavior of the graphical diagrams 211.

According to an embodiment, the textual intermediate representation 213, which only represents a graphical diagram 211, may also comprise a section written in a predefined textual basic language defined by the IEC 61131-3 standard, in which the additional information is provided with the basic conditions such as data types and/or variable types of the textual behavior 237 representing the graphical behavior 233. As described above, the corresponding textual behavior 237 is written in the corresponding sublanguage of one of the programming languages ladder diagram, function block language, or sequence language.

In the embodiment shown, the control program 209 is generated in the second generating step 111 based on the modified textual intermediate representation 227 or based on the textual overall intermediate representation and/or based on the modified graphical diagram 231 or the plurality of modified graphical diagrams 231.

In the embodiment shown, the case is described in which a modification of the textual intermediate representation 213 and, based thereon, a modification of the graphical diagram 211 is achieved by the user carrying out a textual programming operation based on the textual intermediate representation 213.

For this purpose, the user removes textual program objects 225 from the textual intermediate representation 213 in the form of textual input commands 223 or adds further textual program objects 247 to the textual intermediate representation 213. By modifying the textual intermediate representation 213 by the user by carrying out the textual programming operation, a correspondingly modified graphical diagram 231 may be generated after translating the modified textual intermediate representation 227 generated by carrying out the modification.

The user may thus advance the programming of the control program 209 based on the graphical programming language both by carrying out a graphical programming operation and by carrying out a textual programming operation.

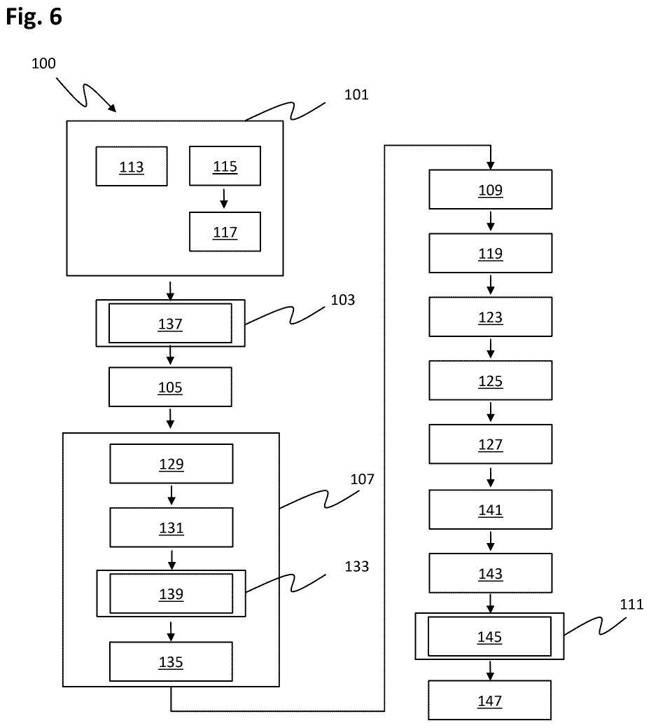

FIG. 6 shows a further flowchart of the method 100 for generating a control program 209 for an automation system according to a further embodiment.

The embodiment in FIG. 6 is based on the embodiment in FIG. 5 and comprises all the method steps described therein. If these remain unchanged in the embodiment shown, a detailed description is dispensed with.

In the embodiment shown, the first generating step 103 comprises an identity determining step 137. In the identity determining step 137, identities 243 of the graphical program objects 217 of the graphical diagram 211 are determined. The identities 243 allow for unique identification of the respective graphical program objects 217.

Furthermore, the first translating step 107 comprises a behavior determining step 129. In the behavior determining step 129, the graphical program objects 217 and a graphical behavior 233 of the graphical diagram 211 are determined.

According to the application, the graphical behavior 233 is a graphical representation of a program sequence of the control program 209.

In a behavior translating step 131, the graphical program objects 217 and the graphical behavior 233 are then translated into textual program objects 225 and a textual behavior 237 of the textual intermediate representation 213. The textual behavior 237 represents a textual representation of the program sequence of the control program 209.

In a line translating step 133, the graphical diagram 211 is then translated line by line into the intermediate representation 213. In the line-by-line translation, each graphical program object 217 is assigned at least one textual program object 225 in the form of a textual line 241 of the textual intermediate representation 213. The textual lines 241 represent a unique description of the respective graphical program objects 217.

In an integrating step 139, the previously determined identities 243 of the graphical program objects 217 are integrated into the respective textual program objects 225 represented by the textual lines 241.

In an arranging step 135, the textual behavior 237 is then arranged within the textual intermediate representation 213 at the behavior position 239. The behavior position 239 defines the arrangement of the textual behavior 237 within the textual intermediate representation 213.

The individual textual program objects 225 represented as textual lines 241 may be arranged according to the integrated identities 243.

Furthermore, in the embodiment shown, a debugging process of the control program 209 is carried out in a debugging step 143 based on the textual intermediate representation 213 or the modified textual intermediate representation 227.

Furthermore, the second generating step 111 comprises a binary code generating step 145. In the binary code generating step 145, a binary representation of the control program 209 is generated in order to generate the control program 209.

Finally, in a storing step 147, the textual intermediate representation 213 or the modified textual intermediate representation 227 on which the generated control program 209 is based is stored in a representation file 245.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

TABLE 1
List of reference numerals

| | |
|---|---|
| 100 | Method |
| 101 | Receiving step |
| 103 | First generating step |
| 105 | First displaying step |
| 107 | First translating step |
| 109 | Second displaying step |
| 111 | Second generating step |
| 113 | Graphical programming step |
| 115 | Reading step |
| 117 | Second translating step |
| 119 | Textual programming step |
| 121 | Third generating step |
| 123 | Third translating step |
| 125 | Third displaying step |
| 127 | Fourth displaying step |
| 129 | Behavior determining step |
| 131 | Behavior translating step |
| 133 | Line translating step |
| 135 | Arranging step |
| 137 | Identity determining step |
| 139 | Integrating step |
| 141 | Summarizing step |
| 143 | Debugging step |
| 145 | Binary code generating step |
| 147 | Storing step |
| 200 | Development environment |
| 201 | Graphical editor unit |
| 203 | Textual editor unit |
| 205 | Translation module |
| 207 | Input data |
| 209 | Control program |
| 211 | Graphical diagram |
| 213 | Textual intermediate representation |
| 215 | Graphic input command |
| 217 | Graphical program object |
| 219 | Executable program object |
| 221 | Program file |
| 223 | Textual input command |
| 225 | Textual program object |
| 227 | Modified textual intermediate representation |
| 229 | Further graphical program object |
| 231 | Modified graphical diagram |
| 233 | Graphical behavior |
| 235 | Graphical object position |
| 237 | Textual behavior |
| 239 | Behavior position |
| 241 | Textual line |
| 243 | Identity |
| 245 | Display file |
| 247 | Further textual program object |
| 249 | Node object |
| 251 | Edge object |
| 253 | Textual object position |
| 255 | Textual additional information |

1. A computer-implemented method for generating a control program for an automation system, comprising:
receiving input data for a control program of an automation system from a development environment in a receiving step, wherein the input data describe a graphical diagram of a graphical programming language, and wherein the graphical diagram graphically represents at least a part of a control program for an automation system according to the graphical programming language;
generating the graphical diagram of the graphical programming language based on the input data by a graphical editor unit of the development environment in a first generating step;
displaying the graphical diagram in the graphical editor unit of the development environment in a first displaying step;
translating the graphical diagram of the graphical programming language into a textual intermediate representation of the graphical diagram by a translation module of the development environment in a first translating step; wherein the textual intermediate representation provides a textual description of the graphical diagram;
displaying the textual intermediate representation of the graphical diagram in a textual editor unit of the development environment in a second displaying step; and
generating the control program based on the textual intermediate representation of the graphical diagram of the graphical programming language and/or based on the graphical diagram in a second generating step.

2. The method according to claim 1, wherein the receiving step comprises:
receiving graphical input commands from a user of a development environment via the graphical editor unit of the development environment in a graphical programming step, wherein the input data comprise graphical input commands,
wherein the graphical input commands comprise programming commands for adding and/or removing graphical program objects of the graphical diagram, and wherein the graphical program objects are partial elements of the graphical diagram and represent program objects of the control program.

3. The method according to claim 1, wherein the receiving step comprises:
reading in a program file in a reading step, wherein the program file contains the input data of the graphical diagram in textual form, wherein the graphical program objects of the graphical diagram are described textually by the input data;
translating the textual input data into the graphical diagram by the translation module in a second translating step.

4. The method according to claim 1, further comprising:
receiving textual input commands from the user via the textual editor unit of the development environment in a textual programming step, wherein textual program objects as textual representations of corresponding graphical program objects of the graphical diagram are added to the textual intermediate representation of the graphical diagram or removed therefrom with the textual input commands;
generating a modified textual intermediate representation based on the textual input commands and the textual intermediate representation of the graphical diagram in a third generating step;
translating the modified textual intermediate representation into a correspondingly modified graphical diagram of the graphical programming language and/or translating textual modifications of the textual intermediate representation caused by the textual input commands into graphical modifications of the graphical diagram with the translation module in a third translating step, wherein the textual modifications comprise at least one newly added or deleted textual program object, and wherein the graphical modifications comprise at least one newly added or deleted graphical program object;
displaying the modified graphical diagram instead of the graphical diagram and/or displaying the graphical modifications in the graphical diagram in the graphical editor unit in a third displaying step; and
generating the control program based on the modified textual intermediate representation of the modified graphical diagram and/or based on the modified graphical diagram in the second generating step.

5. The method according to claim 4, further comprising:
displaying the modified textual intermediate representation of the modified graphical diagram in the textual editor unit in a fourth displaying step.

6. The method according to claim 1, wherein the first translating step further comprises:
determining the graphical program objects and a graphical behavior of the graphical diagram in a behavior determining step, wherein the graphical behavior describes a graphical representation of a program flow of the control program; and
translating the graphical program objects and the graphical behavior of the graphical diagram into textual program objects and a textual behavior of the textual intermediate representation in a behavior translating step, wherein the textual behavior represents a textual intermediate representation of the execution of the control program.

7. The method according to claim 1, wherein the first translating step comprises:
carrying out a line-by-line translation in a line translating step,
wherein in the line-by-line translation, each graphical program object is assigned at least one textual program object in the form of at least one textual line of the textual intermediate representation, and
wherein the textual lines contain unique descriptions of the respective graphical program objects.

8. The method according to claim 7, wherein the first translating step comprises:
arranging the textual behavior at a behavior position within the textual intermediate representation in an arranging step,
wherein the behavior position defines a position predefined by an IEC 61131-3 standard in a program code at which a behavior of a control program is to be positioned.

9. The method according to claim 1, wherein the first generating step comprises:
determining identities of the graphical program objects of the graphical diagram in an identity determining step, wherein the identities of the graphical program objects allow for unique identification of the respective graphical program objects; and
wherein the line translating step comprises:
integrating the identities of the graphical program objects into the respective program objects of the textual intermediate representation assigned to the graphical program objects and written in textual lines in an integrating step.

10. The method according to claim 1, further comprising:
summarizing the textual intermediate representation of the graphical diagram with at least one further intermediate representation of at least one further graphical diagram to form a textual overall intermediate representation in a summarizing step,
wherein the overall intermediate representation summarizes a plurality of different textual intermediate representations of a plurality of different graphical diagrams into a coherent code in textual form.

11. The method according to claim 1s, wherein the second generating step comprises carrying out a debugging process based on the textual intermediate representation of the graphical diagram in a debugging step.

12. The method according to claim 1, wherein the second generating step comprises generating a binary representation of the control program in a binary code generating step.

13. The method according to claim 1, further comprising storing the textual representation in a representation file in a storing step.

14. The method according to claim 1, wherein the graphical programming language is any one of the following: contact diagram, function block language, flowchart language.

15. The method according to claim 1, wherein a syntax of the textual intermediate representation and the modified textual intermediate representation is conflict-free with a syntax of the graphical programming language.

16. A development environment having a graphical editor unit, a textual editor unit and a translation module according to claim 1, wherein the development environment is configured to carry out the method.
